(19) United States
(12) Patent Application Publication
(10) Pub. No.: US 2008/0197010 A1
(43) Pub. Date: Aug. 21, 2008

(54) APPARATUS AND METHOD FOR AIR RELIEF IN AN AIR SWITCH

(76) Inventor: Chih Lin, Piqua, OH (US)

Correspondence Address: MICHAEL BEST & FRIEDRICH LLP, 100 E WISCONSIN AVENUE, Suite 3300, MILWAUKEE, WI, 53202, US

(21) Appl. No.: 12/034,179

(22) Filed: Feb. 20, 2008

Related U.S. Application Data
(60) Provisional application No. 60/890,857, filed on Feb. 21, 2007.

(51) Int. Cl. H01H 35/28

(52) U.S. Cl. 200/83 R

(57) ABSTRACT

A switch assembly includes a switch operable to generate a signal, and a housing fixedly supporting the switch. The housing has a fluid conduit operable to fluidly connect to a fluid line. The switch assembly also includes a diaphragm supported by the housing and operable to affect the switch. The diaphragm and the housing form a variable volume chamber communicating with the fluid conduit. The diaphragm and the housing also form a fluid bleed passage therebetween. The fluid bleed passage permits controlled fluid flow from the chamber to ambient outside the housing.

### RELATED APPLICATIONS

This application claims priority to U.S. Provisional Patent Application No. 60/890,857, filed on Feb. 21, 2007, the contents of which are incorporated herein by reference.

### BACKGROUND

The present invention relates to air switches and/or pressure detecting/measuring components for electric motors utilized in jetted fluid applications. More specifically, the invention relates to a switch assembly utilized to sense a fluid pressure and operate an electrical motor as a result thereof. The main purpose of the switch assembly is its use as a safety device in jetted fluid applications. For example, a person in a tub filled with water may operate the switch assembly remotely to activate or deactivate the electrical motor. Thus, the risk of electrocution is minimized.

The present invention also relates to pneumatic actuated switches used in applications where it is desirable to actuate an electrical component at a remote location by means of a pulse of air. Such switches are often utilized in applications where the switch is exposed to elevated temperatures (e.g., furnace, hot tub, spa, jetted bathtub applications or the like). In such environments, air confined within a pressure chamber, channel or conduit communicating with the actuator of the switch, may at elevated temperatures expand sufficiently to activate the switch.

### SUMMARY

In one embodiment, the invention provides an electric motor for jetted fluid applications, the motor comprising: a control assembly for operating the motor; and a switch assembly connected to the control assembly, the switch assembly including a switch operable to generate a signal and send the signal to the control assembly, a housing fixedly supporting the switch, the housing having a fluid conduit operable to fluidly connect to a fluid line, and a diaphragm supported by the housing and operable to affect the switch, the diaphragm and the housing forming a variable volume chamber communicating with the fluid conduit, the diaphragm and the housing also forming a fluid bleed passage therebetween, the fluid bleed passage permitting controlled fluid flow from the chamber to ambient outside the housing.

In another embodiment, the invention provides a switch assembly comprising: a switch operable to generate a signal; a housing fixedly supporting the switch, the housing including a fluid conduit operable to fluidly connect to a fluid line; and a diaphragm supported by the housing and operable to affect the switch, the diaphragm and the housing forming a variable volume chamber communicating with the fluid conduit, the diaphragm and the housing also forming a fluid bleed passage therebetween, the fluid bleed passage permitting controlled fluid flow from the chamber to ambient outside the housing.

Other aspects of the invention will become apparent by consideration of the detailed description and accompanying drawings.

### BRIEF DESCRIPTION OF THE DRAWINGS

FIG. 1 is an elevation view of a switch assembly.

FIG. 2 is a bottom view of the switch assembly.

FIG. 3 is a partial cross-section view of the switch assembly taken along line 3-3 in FIG. 2.

FIG. 4 is an exploded view of the partial cross-section shown in FIG. 3.

FIG. 5 is a perspective view of an upper housing of the switch assembly.

FIG. 6 is an elevation view of a button or starwheel of the switch assembly.

FIG. 7 is a top view of the button or starwheel of the switch assembly.

FIG. 8 is a perspective view of a sleeve of the switch assembly.

FIG. 9 is a top view of a lower housing of the switch assembly.

FIG. 10 is a perspective view of a cup and a diaphragm of the switch assembly.

FIG. 11 is a partial cross-section view of the lower housing taken along line 9-9 in FIG. 7 also showing a portion of the diaphragm.

FIG. 12 is a partial view of a motor control assembly including the switch assembly.

FIG. 13 is a schematic view of the motor control assembly and switch assembly shown in FIG. 12.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

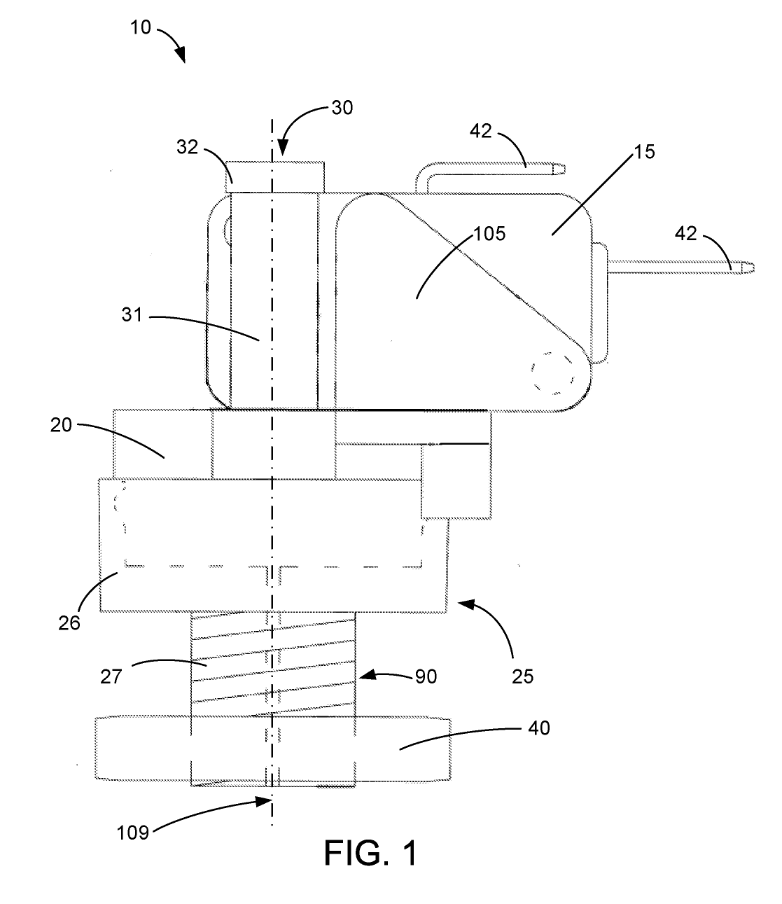

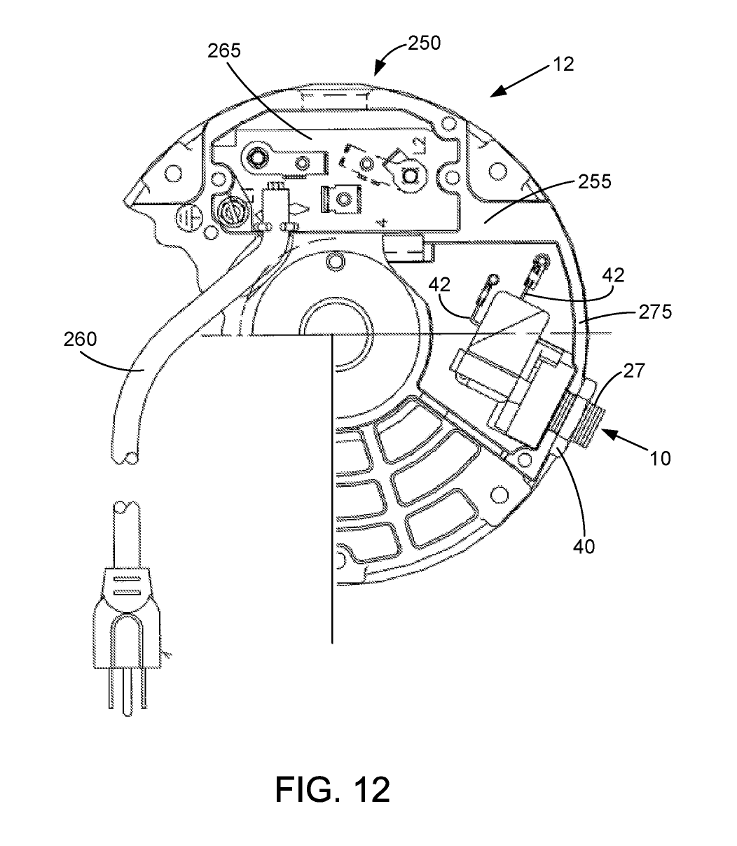

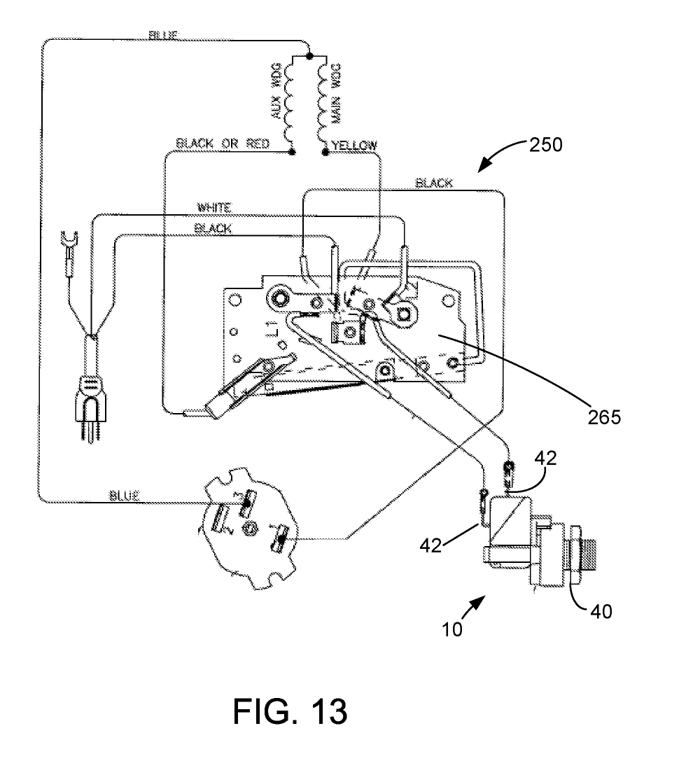

FIG. 1 is an elevation view of a switch assembly 10 operable to operate an electric motor 12 (partially shown in FIGS. 12 and 13) generally used in jetted fluid applications (e.g., a jetted tub). For example, the switch assembly 10 can be operable to turn on and off the motor, although other applications for the switch assembly 10 fall within the scope of the invention. The switch assembly 10 is in many respects similar to the switch disclosed in U.S. Pat. No. 5,471,022, which is incorporated herein by reference. The most significant difference between the switch assembly 10 and U.S. Pat. No. 5,471,022 is the improved air bleed arrangement or passage of the switch assembly 10.

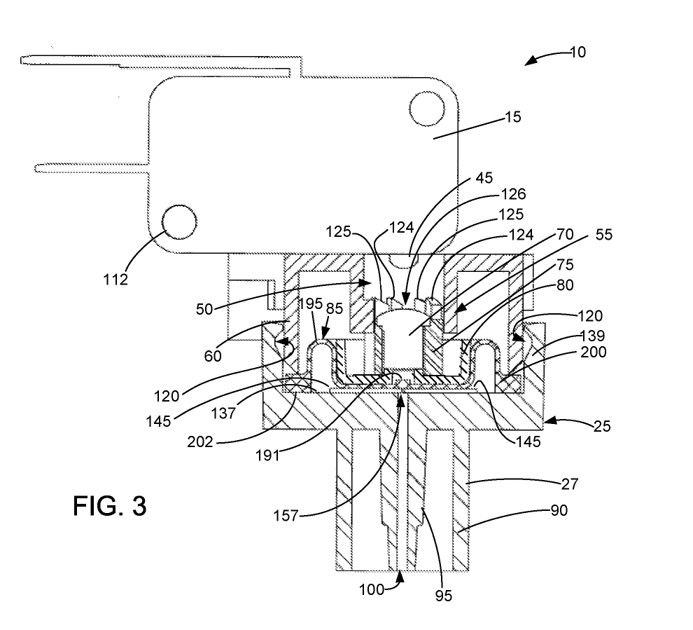

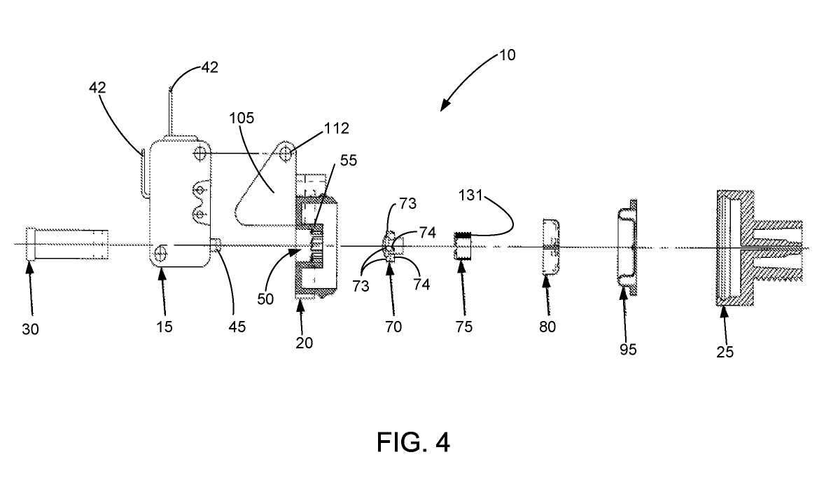

The switch assembly 10 includes a switch 15 operable to generate a signal and mounted to an upper housing 20, a lower housing 25 coupled to the upper housing 20, and a U-shaped clip 30 that secures the switch 15 to the upper housing 20. The switch 15 includes two electrical connectors 42 and an actuator or button 45 (shown in FIGS. 3 and 4). The button 45 is biased outward by a spring (not shown). Pushing the button 45 a single time changes the state of the switch 15. Thus, when the switch 15 is open, pushing the button 45 closes the switch, and the button 45 pops back out when the force on the button 45 is removed. The switch 15 then stays closed until the button 45 is pushed again, at which point the switch 15 opens, and the button 45 again pops out when the force on the button 45 is removed. The switch 15 then stays open until the button 45 is pushed again. This cycle repeats indefinitely. The connectors 42 are utilized to electrically connect the switch assembly 10 to a motor control assembly 250 as shown schematically in FIG. 13, for example. In some constructions, the switch 15 can be an on/off switch such that actuation of the switch 15 causes the motor to start or stop operation. Other constructions can include the switch 15 operating different functions of the motor control assembly 250 based on desired specifications.

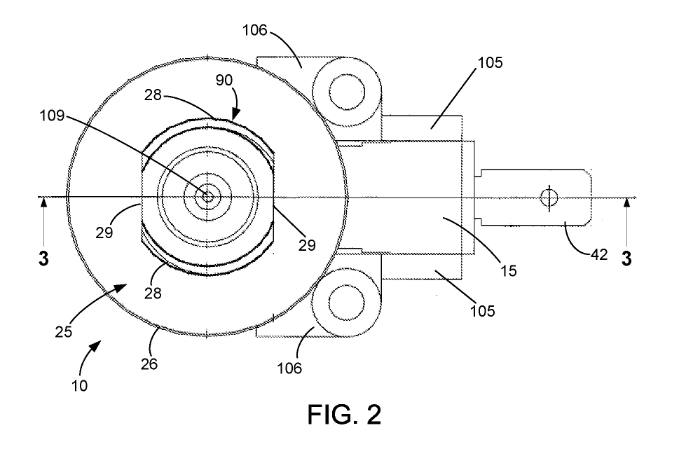

The U-shaped clip 30 includes two leg portions 31 (only one shown in FIG. 1) extending downward from opposite ends of a head portion or cross member 32. Each of the leg portions 31 includes a latch device (not shown) for coupling the U-shaped clip 30 to the upper housing 20 such that the switch 15 remains in a stable position with respect to the upper housing 20. The lower housing 25 includes an upper portion 26 and a lower or intake portion 27. The lower portion 27 includes a generally cylindrical wall 90 having two partially threaded surfaces 28 and two flat surfaces 29, as shown in FIG. 2. The wall 90 is centered on a central axis 109. The lower portion 27 is operable to receive a fluid line (further explained below) and cooperates with a nut 40 to mechanically couple the switch assembly 10 to the motor control assembly 250 as shown in FIG. 12, for example. It is to be understood that the switch assembly 10 as described herein is only for exemplary purposes such that other constructions of the switch assembly fall within the scope of the invention.

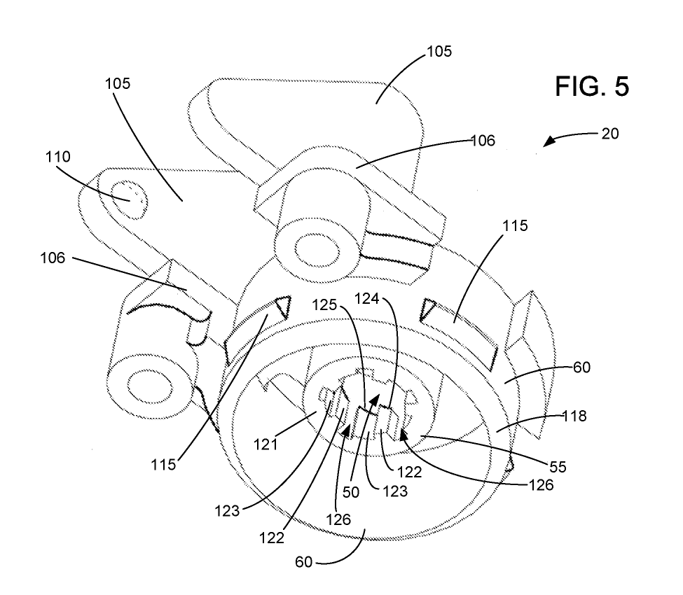

FIG. 2 is a bottom view of the switch assembly 10 showing the upper portion 26 of the lower housing 25 having a substantially cylindrical outer surface. FIG. 2 also shows one electrical connector 42 extending from the switch 15. The switch 15 is coupled to the upper housing 20 between (see FIGS. 1, 2 and 5) two plates 105 and two extensions 106. As shown more specifically in FIG. 5, the two plates 105 of the upper housing 20 define a substantially triangular shape, and each includes a projection 110 (only one shown in FIG. 5). In other constructions of the upper housing 20, the plates 105 can define a different shape. The projection 110 of each plate 105 extends into a recess 112 (only one shown in FIG. 3) defined on each side of the switch 15 providing improved support of the switch 15 with respect to the upper housing 20. The upper housing 20 also includes four coupling protrusions 115 (two shown in FIG. 5) extending radially outward from an outer wall 60. The protrusions 115 snap into a groove 120 in a cylindrical wall 139 of the lower housing 25 (shown in FIG. 3) to couple the upper housing 20 and the lower housing 25.

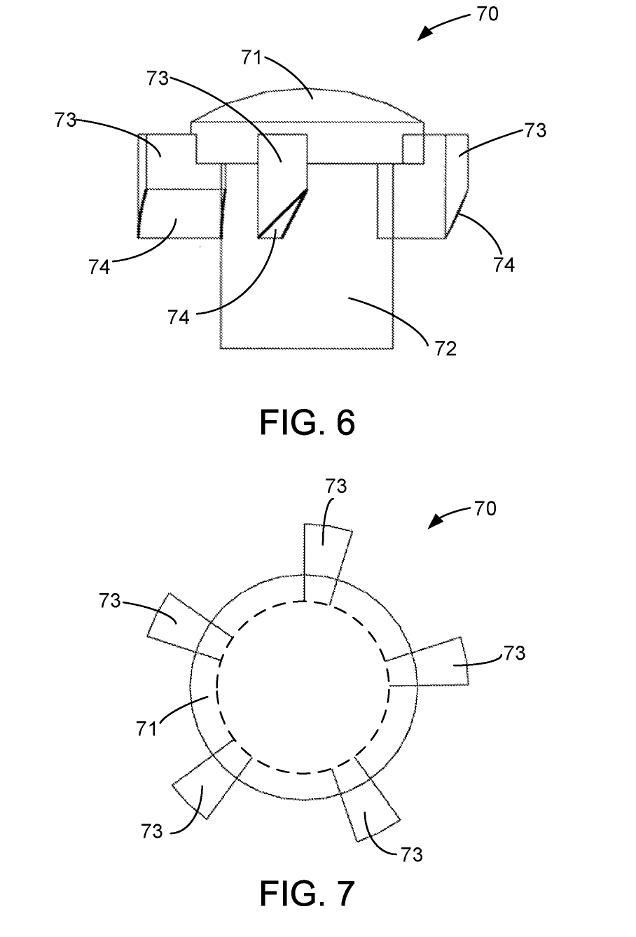

Still with reference to FIG. 5, the upper housing 20 also includes a first inner space 50 defined by a generally cylindrical inner wall 55. The inner wall 55 includes a flat end surface 121 and five pairs of adjacent ribs 122, 123 axially extending along the inner surface of the inner wall 55 and parallel to the central axis 109. The upper ends of the ribs 122, 123 have inclined camming surfaces 124, 125, respectively (shown in FIG. 3). Two pairs of adjacent ribs 122, 123 define therebetween axially extending gaps 126. The outer wall 60 includes a chamfered contact surface 118, although other constructions of the upper housing 20 can include a contact surface defining a plane substantially parallel to the flat surface 121, for example. The inner wall 55 of the upper housing 20 is designed to receive a button or starwheel 70 (shown in FIGS. 3, 4, 6 and 7) and a sleeve 75 (shown in FIGS. 3, 4 and 8).

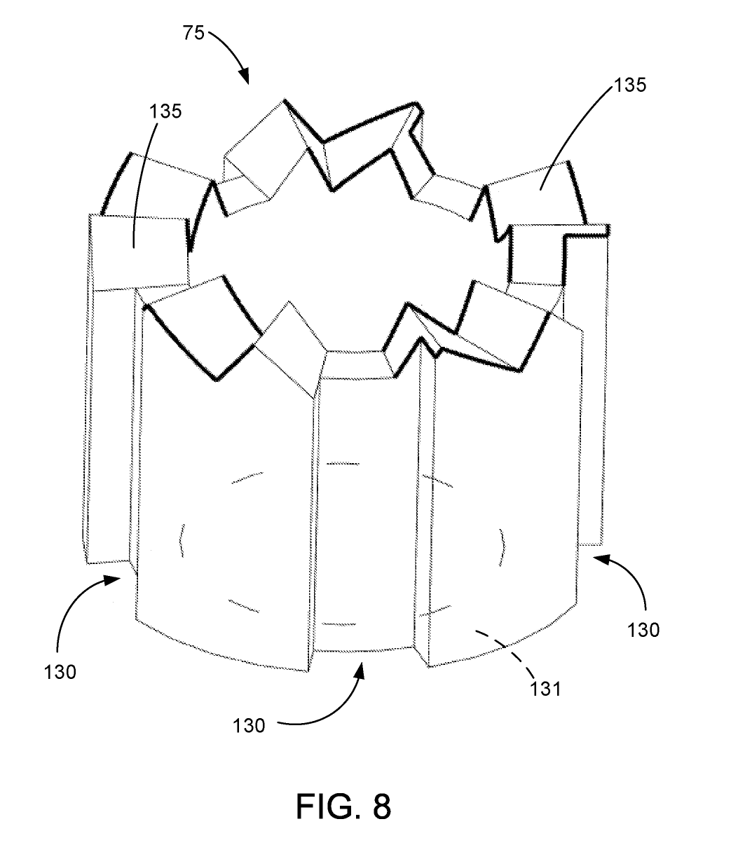

As shown in FIGS. 3, 6 and 7, the starwheel 70 includes a head portion 71 and a body portion 72. The body portion 72 slidingly fits within the sleeve 75. Five projections or arms 73 extend radially outward from the body portion 72, and the lower end of each arm 73 has an inclined surface 74. The surfaces 74 are engageable both with the surfaces 124, 125 of the upper housing 20 and with the sleeve 75, as described below. As shown in FIG. 8, the sleeve 75 defines a substantially cylindrical shape and includes five axially extending grooves 130. The grooves 130 on the sleeve 75 interact with the ribs 122, 123 on the inner wall 55 to prevent pivotal movement of the sleeve 75 within the upper housing 20 and yet allow the sleeve 75 to slide axially with respect to the inner wall 55. The sleeve 75 also includes inclined upper surfaces 135 operable to engage the inclined surfaces 74 of the starwheel 70. The sleeve 75 also has a flat lower surface 131 contacting a cup or pressure plate 80 (shown in FIGS. 3, 4 and 10).

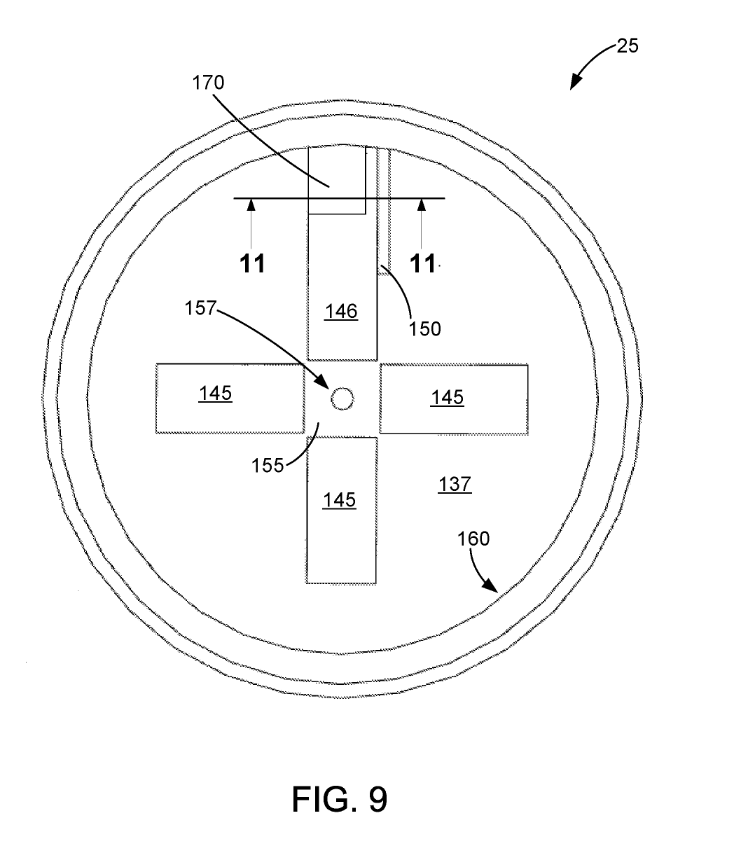

FIGS. 3 and 4 illustrate the structural arrangement of the air switch assembly 10. More specifically, FIG. 3 is a partial cross-section of the air switch assembly 10 and FIG. 4 is an exploded view of the partial cross-section shown in FIG. 3. As shown in FIGS. 3 and 4, the switch 15 is mounted onto the upper housing 20 such that the switch actuator or button 45 is placed within the first inner space 50. Also shown are the lower housing 25 coupled to the upper housing 20, and the starwheel 70, the sleeve 75, the cup 80, and a diaphragm 85 generally manufactured of an elastomer material and mounted between the lower housing 25 and the upper housing 20. The lower portion 27 of the lower housing 25 includes a tapered tubular inlet portion or nozzle 95 with an air flow conduit 100 extending to an air inlet 157 (better shown in FIG. 9) on an inner surface 137 of the lower housing 25. The surface 137 is generally planar and perpendicular to the axis 109.

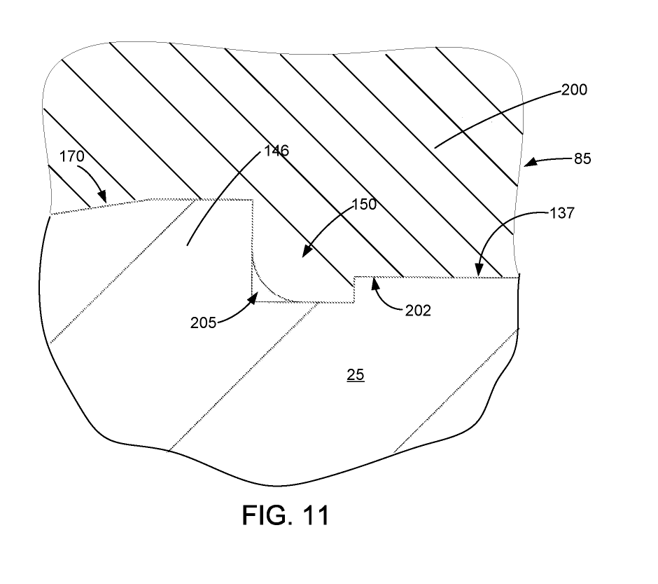

As shown in FIG. 9, the lower housing also includes three similar spacer pads 145 protruding from the inner surface 137, a modified spacer pad 146 also extending from the inner surface 137, and an air bleed channel 150 adjacent to spacer pad 146. Other constructions of the lower housing 25 can include a different number of spacer pads 145. In yet other constructions, one or more ridges can extend from the surface 137. Spacer pads 145, 146 extend radially outward from a center portion 155 of the inner surface 137 toward an outer edge 160 of the inner surface 137. The outer edge 160 is generally defined by the intersection of the inner surface 137 and the wall 139 of the lower housing 25. The pads 145, 146 have planar upper surfaces parallel to the surface 137. The spacer pad 146 also has a ramp 170 defining a surface at an inclined angle with respect to the inner surface 137. As seen in FIGS. 9 and 11, the ramp 170 is inclined upward from left to right, or toward the channel 150. The radial extent (from top to bottom in FIG. 9) of the ramp 170 is approximately equal to the radial width of the diaphragm surface 202 described below. In other constructions, the lower housing 25 can include a ramp independently formed from pads 145, 146 and extending from the surface 137. Moreover, the ramp can define a ridge formed adjacent to the channel 150.

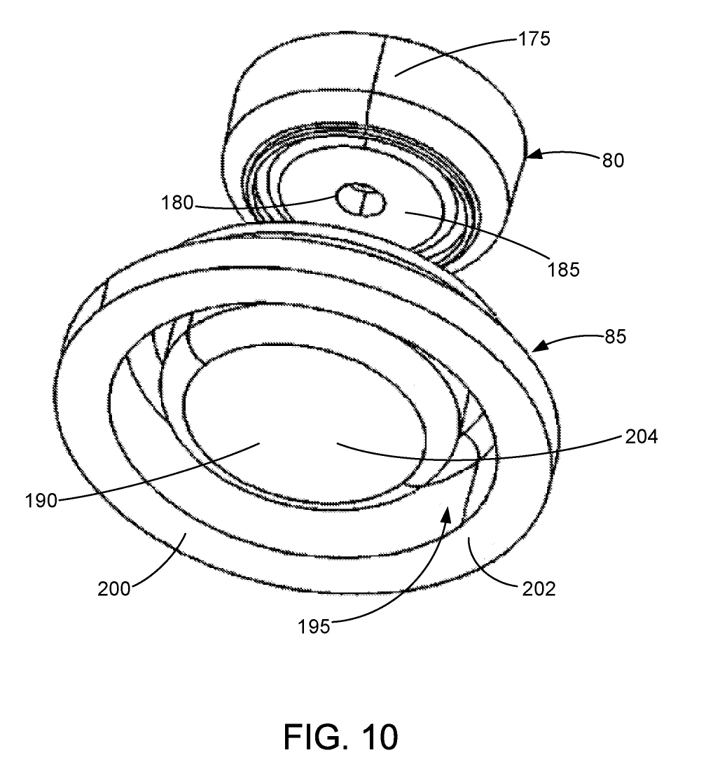

As shown in FIG. 10, the cup 80 includes a substantially cylindrical outer wall 175 and a circular aperture 180 at the center of a generally planar surface 185. The circular aperture 180 is designed to receive a protrusion 191 of the diaphragm 85 (shown in FIG. 3). The protrusion 191 is usually a product of the manufacturing of the diaphragm 85. However, the protrusion 191 is not necessary to the invention. The diaphragm 85 includes an annular outer base portion 200 having a generally planar bottom surface 202. The surface 202 normally rests on the surface 137 radially outward of the pads 145. However, the surface 202 of the diaphragm 85 contacts the ramp portion 170 of the pad 146. As a result, the diaphragm 85 and the lower housing 25 form a seal between the inner portion and the outer portion of the diaphragm 85. In addition, the diaphragm 85 and the portion of the surface 137 including the channel 150 provide or form a compromised portion of the seal formed between the diaphragm 85 and the lower housing 25 allowing a controlled fluid flow, as further explained below. The diaphragm 85 also includes a generally U-shaped convolute portion 195 radially inward of the base 200, and a generally flat innermost portion 204 having a generally planar bottom surface 190. The bottom surface 190 and portion 195 of the diaphragm 85 cooperate with surface 137 to form a variable volume chamber therebetween. For example, the bottom surface 190 rests on the pads 145, 146 of the surface 137 during absence of fluid pressure within the variable volume chamber. Consequently, the pads 145, 146 maintain a space between the surfaces 137 and 190 of the lower housing 25 and diaphragm 85, respectively.

FIG. 11 is a partial cross-section of the lower housing 25 and the diaphragm 85. As indicated above, the upper housing 20 is engaged with the lower housing 25 such that the outer wall 60 engages the base portion 200 of the diaphragm 85. As a result of such engagement, the base portion 200 of the diaphragm 85 is “sandwiched” between the contact surface 118 of the upper housing 20 and the inner surface 137 of the lower housing 25. The diaphragm 85 and lower housing 25 form a seal between the base portion 200 and the surface 137, except for the compromised seal portion. During operation of the switch assembly 10, the nozzle 95 of the lower housing 25 can be coupled to an air line or tubing (not shown). An increase in pressure within the air line can cause the diaphragm 85 to deform in the direction of the cup 80, or upward in FIG. 3. Thus, increasing the volume of the variable volume chamber. A sufficient increase in pressure within the air line can cause the diaphragm 85 to push the cup 80, sleeve 75 and starwheel 70 upward to actuate the switch 15. This is further described below.

In the illustrated construction, the base portion 200 of the diaphragm 85 contacts the ramp 170 of the pad 146. The bottom surface 202 of the base portion 200 sealingly engages the ramp 170 and the top of the pad 146. The base portion 200 also cooperates with the channel 150 and pad 146 to form a fluid bleed passage, further described below. The air bleed channel 150 has a length (from top to bottom in FIG. 9) greater than the radial width of the base portion 200, so that the channel 150 communicates between the opposite sides of the base portion 200. When the diaphragm 85 is mounted between the upper housing 20 and the lower housing 25, the base portion 200 is deformed and pushed downward into the channel 150, but the diaphragm 85 is designed such that the base portion 200 does not entirely fill the channel 150. The base portion 200 fills a substantial portion of the air bleed channel 150 leaving an air or fluid bleed passage 205 (FIG. 11) defined by the portion of the channel 150 not filled with the diaphragm 85. This passage 205 extends across the radial width of the base portion 200 and communicates between the opposite sides of the base portion 200. It is within the scope of the invention that the lower housing 25 includes other deformations such that cooperation or contact of the diaphragm 85 with the lower housing 25 (at such deformations) also forms the fluid bleed passage 205.

The fluid passage 205 formed by the air bleed channel 150 and the diaphragm 85 provides a controlled relief of air pressure in the event of sudden changes of ambient temperature. For example, a change in ambient temperature can cause a relatively small increase in pressure within the air line connected to the air flow conduit 100, which can cause undesired actuation of the switch 15 due to an increment in volume of the variable volume chamber. The fluid passage 205 allows the switch assembly 10 to release air or fluid in a controlled manner and to decrease pressure caused by temperature fluctuations. Other constructions of the switch assembly 10 can include additional channels and/or fluid bleed passages for controllably releasing fluid to ambient outside the upper and lower housings 20, 25.

During normal operation of the switch assembly 10, pressure beneath the diaphragm 85 (within the variable volume chamber) increases sufficiently such that the fluid flow though the fluid bleed channel is negligible. The diaphragm 85 moves upward pushing the cup 80, which causes the sleeve 75 to move upward and engage the starwheel 70, moving the starwheel 70 into contact with the button 45. The spring force of the button 45 exerts a downward force on the starwheel 70. In addition to moving the starwheel 70 upward, the sleeve 75 also causes the starwheel 70 to rotate. The inclined surfaces 135 on the sleeve 75 engage the inclined surfaces 74 on the starwheel 70 to cause slight rotation of the starwheel 70. This slight rotation affects where the inclined surfaces 74 of the starwheel 70 contact the cam surfaces 124, 125 on the upper housing 20, and the point of contact between the arms 73 of the starwheel 70 and the cam surfaces 124,125 determines the operating position of the starwheel 70. Engagement of inclined surfaces 74 with the cam surfaces 124, 125 produces a rotational effect on the starwheel 70. Also, the configuration of the pairs of cam surfaces 124, 125 and the gaps 126 causes the starwheel 70 to move between its two positions. In this respect, movement of diaphragm 85 and the cup 80 cause the sleeve 75 to move the starwheel 70 against the switch button 45. The sleeve 75 has sufficient travel to move the lower inclined edges 74 of the arms 73 above the cam surfaces 124, 125. As mentioned above, the inclined surfaces 135 on the sleeve 75 will cause the starwheel 70 to rotate slightly. When the pressure is removed from diaphragm 85, the biasing force of the switch button 45 will cause the starwheel 70 to move downward, and the inclined surfaces 74 will engage either cam surface 124 or cam surface 125.

If an arm 73 engages a cam surface 125 it will slide down the surface 125 until it abuts the step between that surface and the adjacent surface 124. The starwheel 70 is then in its first “switch activated” position, wherein it keeps the switch button 45 in a depressed, activated state. With the next pressure pulse in the variable volume chamber beneath the diaphragm 85, the diaphragm 85 and the cup 80 cause the sleeve 75 to move the starwheel 70 off of the cam surface 125 a sufficient distance to clear the step. Again, the sleeve 75 causes slight axial rotation of the starwheel 70, such that when the pressure is removed from diaphragm 85, the arm 73 contacts the cam surface 124. As the biasing force of the switch button 45 forces the starwheel 70 downward, the arms 73 slide down the cam surfaces 124 until the arms 73 align with the gaps 126. In this position, the starwheel 70 is forced away from the switch 15 by the biasing force of the button 45, until the button 45 is no longer depressed. With the arms 73 of the starwheel 70 aligned in the gaps 126, the starwheel 70 moves downward to its second or “switch deactivated” position, which is shown in FIG. 3. A subsequent pressure pulse will move the starwheel 70 to its switch actuated position in the manner previously described.

FIGS. 12 and 13 illustrate one exemplary construction of the switch assembly 10 and a motor control assembly 250. As shown in FIG. 12, the control assembly 250 is mounted to a frame 255 and includes a power line 260 and a control circuit 265. As shown in FIG. 13, the connectors 42 of the switch assembly 10 are electrically coupled to a pair of connectors of the control assembly 250. The frame 250 also includes an outer wall 275 to which the switch assembly 10 is mechanically coupled. More specifically, the lower portion 27 of the lower housing 25 extends through the outer wall 275 such that the lower portion 27 is placed outside of the frame 255. The nut 40 secures the switch assembly 10 to the frame 255. FIG. 13 shows a schematic representation of the switch assembly 10 electrically connected to the control assembly 250. The connectors 42 are connected to the control circuit 265 such that the switch assembly 10 can operate the control assembly 250 when the switch 15 is actuated.

Various features and advantages of the invention are set forth in the following claims.

What is claimed is:

1. An electric motor assembly comprising:
an electric motor;
a control assembly for operating the motor; and
a switch assembly connected to the control assembly, the switch assembly including
a switch operable to generate a signal and send the signal to the control assembly,
a housing fixedly supporting the switch, the housing having a fluid conduit operable to fluidly connect to a fluid line, and
a diaphragm supported by the housing and operable to affect the switch, the diaphragm and the housing forming a variable volume chamber communicating with the fluid conduit, the diaphragm and the housing also forming a fluid bleed passage therebetween, the fluid bleed passage permitting controlled fluid flow from the chamber to ambient outside the housing.

2. The assembly of claim 1, wherein the housing includes a first portion fixedly supporting the switch, and a second portion coupled to the first portion and including the fluid conduit, wherein one portion of the diaphragm is pressed between first portion and the second portion, and wherein the one portion of the diaphragm and the second portion of the housing define the fluid bleed passage therebetween.

3. The assembly of claim 1, wherein the housing includes a surface against which the diaphragm normally seals, the surface having thereon a deformation that cooperates with the diaphragm to form the fluid bleed passage.

4. The assembly of claim 1, wherein the housing includes a surface against which the diaphragm normally seals, the surface having therein a channel that cooperates with the diaphragm to form the fluid bleed passage.

5. The assembly of claim 4, wherein the surface includes a ramp surface adjacent the channel, and wherein the diaphragm contacts the ramp surface.

6. The assembly of claim 5, wherein the ramp surface at least partially forms a ridge adjacent the channel such that the ridge and the channel cooperate to form the fluid bleed passage.

7. The assembly of claim 1, wherein the housing includes a ridge, and wherein the diaphragm cooperates with the ridge to form the fluid bleed passage.

8. The assembly of claim 7, wherein the housing includes a ramp surface, the ramp surface at least partially defining the ridge.

9. The assembly of claim 8, wherein the housing includes a channel adjacent the ridge such that the ridge and the channel cooperate to form the fluid bleed passage.

10. The assembly of claim 1, wherein the fluid conduit is an air conduit.

11. The assembly of claim 1, wherein the housing includes a surface engaged by the diaphragm to form a seal, the surface and the diaphragm cooperating to provide a compromised portion of the seal that forms the fluid bleed passage.

12. A switch assembly comprising:
a switch operable to generate a signal;
a housing fixedly supporting the switch, the housing including a fluid conduit operable to fluidly connect to a fluid line; and
a diaphragm supported by the housing and operable to affect the switch, the diaphragm and the housing forming a variable volume chamber communicating with the fluid conduit, the diaphragm and the housing also forming a fluid bleed passage therebetween, the fluid bleed passage permitting controlled fluid flow from the chamber to ambient outside the housing.

13. The switch assembly of claim 12, wherein the housing includes a first portion fixedly supporting the switch, and a second portion coupled to the first portion and including the fluid conduit, wherein one portion of the diaphragm is pressed between first portion and the second portion, and wherein the one portion of the diaphragm and the second portion of the housing define the fluid bleed passage therebetween.

14. The switch assembly of claim 12, wherein the housing includes a surface against which the diaphragm normally seals, the surface having thereon a deformation that cooperates with the diaphragm to form the fluid bleed passage.

15. The switch assembly of claim 12, wherein the housing includes a surface against which the diaphragm normally seals, the surface having therein a channel that cooperates with the diaphragm to form the fluid bleed passage.

16. The switch assembly of claim 15, wherein the surface includes a ramp surface adjacent the channel, and wherein the diaphragm contacts the ramp surface.

17. The switch assembly of claim 16, wherein the ramp surface at least partially forms a ridge adjacent the channel such that the ridge and the channel cooperate to form the fluid bleed passage.

18. The switch assembly of claim 12, wherein the housing includes a ridge, and wherein the diaphragm cooperates with the ridge to form the fluid bleed passage.

19. The switch assembly of claim 18, wherein the housing includes a ramp surface, the ramp surface at least partially defining the ridge.

20. The switch assembly of claim 19, wherein the housing includes a channel adjacent the ridge such that the ridge and the channel cooperate to form the fluid bleed passage.

21. The switch assembly of claim 12, wherein the fluid conduit is an air conduit.

22. The switch assembly of claim 12, wherein the housing includes a surface engaged by the diaphragm to form a seal, the surface and the diaphragm cooperating to provide a compromised portion of the seal that forms the fluid bleed passage.
